(19) United States
(12) Patent Application Publication
(10) Pub. No.: US 2012/0133481 A1
(43) Pub. Date: May 31, 2012

(54) Modular Control and Indicating Panel, Its Use and a Method of Controlling Building Alarm Systems

(75) Inventor: Dalibor Dedek, Jablonec nad Nisou (CZ)

(73) Assignee: Jablotron Alarms A.S., Jablonec nad Nisou (CZ)

(21) Appl. No.: 13/121,514

(22) PCT Filed: Jun. 11, 2010
(86) PCT No.: PCT/CZ10/00069

§ 371 Date: Mar. 29, 2011

(30) Foreign Application Priority Data
Aug. 21, 2009 (CZ) PV 2009-559

(51) Int. Cl. G08B 29/00

(52) U.S. Cl. 340/5.2

(57) ABSTRACT

A modular control and indicating panel for authorized control of functions of electronic intruder alarm system, fire or other danger alarms, for access control and for control of appliances and other electronic devices, characterized by that it comprises at least one control and indicating segment (A) allowing to control particular function, the control segment (A) comprises label (2), buttons (1) and indicators and authorization unit (B) comprises status indicator (3) and is equipped with device for user authorization, the panel is easily physically or virtually compoundable from one or more control and indicating segments (A) and authorization unit (B).

### TECHNICAL FIELD

Presented invention relates to a modular panel comprised of control and indication segment(s) and authorization unit intended primarily to control the intruder alarm systems, fire alarms and other alarm systems. The panel can be optionally used for access control (i.e. electric locks) and to control electric appliances (lights, heating, air-conditioning, roller blinds, etc.) whenever a user authorization is required. The invention also relates to authorization of particular person (or group of persons) to control designated functions of alarm system or designated electric appliances.

### BACKGROUND ART

In the field of intruder alarm system, there are used dedicated indication and control panels (keyboards) usually combining many various functions. Their control is executed by sequence of keystrokes, which may be combined with navigation in a user interface menu.

For end users, such control does not provide an easy survey, it is hardly comprehensible and usually indeterminate (i.e. the code entry sets the alarm system, while entering the same code in another situation unset the system, etc.). All these put user under stress while operating an alarm system.

Current systems are conceived as universal so that they provide a lot more functions than the real installation usually requires. Consequently, its end users rightfully perceive these systems as excessive, redundant and confusing.

Multi-purpose control and indicating panels are designed to provide the control of entire system and not only of some of its parts. If the system, beside the alarm functions (i.e. setting/unsetting alarm system partitions corresponding access rights of particular users), provides the control of ancillary equipment (i.e. switching on/off the lights, air-conditioning control, heating etc.), then it is obvious that such control would be executed by one “universal” device which may provide all these functions. Due to the need of successive clicking or navigating to operate desired function, it is apparent that for end user the use of such control and indicating equipment can be uncomfortable, complicated and stressful. The user does not recognize clearly in which control step he is at the moment and how he should proceed in the following steps (for example in family houses, such problems arise especially for technically less educated or older members of the family).

Given the systems are designed universally so as to be used both in residential (apartments, family houses etc., with a handful of users) and business buildings (offices, shops, warehouse, etc., with up to couple hundred users), they must provide adequate number of functions to fulfill demands of potential customers. In a small family house the majority of functions provided by the system remain idle, and at the same time their presence makes it difficult for the users to use the system appropriately (i.e. undesired navigating trough a list of items of the menu to select right function).

Similarly status indication of particular functions on the control and indicating equipment can be confusing.

The “unhandiness” of contemporarily used systems can be illustrated, for example, by situation while alarm is indicated in a large building: though the multiple control and indicating panels indicate alarm by acoustic and general visual warning, to learn details where the alarm situation occurs one has to come close to the display and read the report (or search for it in the menu). Thus, as mentioned in this example, the clear and prompt visual identification of the problem location is not available.

### DISCLOSURE OF THE INVENTION

Modular (building block structure) control and indicating panel for authorized control of particular functions of building system (preferably security alarm system) comprises of at least one control and indicating segment, which makes it possible to change the status of desired function of the system (for example the setting and unsetting of certain alarm partition or switching on/off the selected appliance) by pushbuttons or by touch sensor or rotation encoder. The control and indicating segment is also equipped with indicators (for example built directly in the control buttons) that clearly show actual status of the controlled function (appliance). The control segment also contains visible notification (text label or display), that informs the user about what function is being controlled and indicated). To match exactly needs of any real installation, an optional number of control and indicating segments may form the desired control and indicating panel.

The control and indicating panel further comprises at least one authorization unit, which is equipped with device for authorization of an authorized user. Authorization unit may be of various designs, with difference being the specific authorization method in use. Following devices can be used (or combined): keyboard, identification chip reader, biometrical data reader (i.e. fingerprint reader) or remote control receiver that receives an identification code. The authorization unit also contains an indicator that informs about the system basic status (its operation or failure, etc.) and also indicates the function of the user authorization process. The authorization unit may contain display which provides more detailed information about the, status of controlled functions (or appliances), or it may contain text guide (instructions) how to proceed.

The authorization unit is usually equipped with cover that makes it possible to hide or access (i.e. by uncovering) the control and display elements. This cover further provides optional function of activation of identification chip reader. The activation of chip reading is triggered by manipulation with the cover (i.e. by uncovering it or by pushing the unopened cover). The activation of identification chip reader by manipulation of the cover is used particularly in wireless option of the authorization unit (to reduce standby energy consumption).

The control and indicating panel can be interconnected with building system other units via wire (cable), eventually wireless by electromagnetic waves. In case of wireless connection, the control and indication panel is supplied with energy from batteries (or combination of batteries and local power supply unit).

Within one system, the multiple control and indication panels can be installed in the building. In such case, all panels can be configured identically providing control of same functions by the same group of people from various access points, or such panels can be configured individually providing control of particular functions in particular access points to different groups of people (for example a family in a particular apartment of an apartment house or a particular office employees in a business building).

Besides the option to mount the control and indicating panel physically from the above described devices, the panel can also be designed virtually, using touch screen and software which visualizes the panel and performs its features.

The use of the control and indicating panel is described subsequently:

Operating buttons (control elements) on particular control and indicating segment, the user selects which function(s) he wants to operate (i.e. setting desired alarm system partition). The indicators of used segment start to indicate desired status change (the indication of change demand differs from general status indication by another color or by blinking). The indication of desired change demand is provided within predefined time period (timeout). Simultaneously, the authorization unit waits for user's authorization (its indicator indicating authorization request). If the user authorizes within provided time limit, then the desired status change is executed (if the user is authorized for this particular function). Multiple status changes can be entered (using multiple control and indicating segments) before the authorization is performed to control multiple functions of the system in the same time (for example setting of 3 particular alarm system partitions with only a single authorization).

The control of functions requiring authorization is also possible conversely—the user can authorize himself by the authorization unit first. The authorization unit then indicates with its indicator the provided time (timeout), during which it is possible to change desired status setting with control segments. If the user operates control segments, then the provided period (timeout) is prolonged, by manipulation time to complete the control process (so that the user can achieve the completion of control of all desired functions).

If user tries to control functions he is not authorized for, the desired invalid status change is not performed.

A chosen function can also be assigned directly to a particular user authorization only—that is, that the predefined function (i.e. the electric door lock opening) is executed instantly after the user authorizes him (no need to use a control segment).

Moreover, particular function control and indicating segments can be set up to provide control without any authorization of users. It means that for example a light can be operated directly by anyone using the particular control segment(s).

The invention is new due to its modularity and possibility to tailor the configuration of control and indicating panel exactly in conformity with given application. The panel is configured by a technician by mechanical installation of control and indicating modules into desired panel with subsequent setting of its features. The setting is performed by a connected external computer of by a programming interface of the system (keypad and display). The control and indicating panel can also by configured virtually if it is interpreted by a touch screen display.

The advantages of this invention are especially:
An option to create control and indicating panel of a building system in the way that it corresponds precisely and unambiguously to desired functions;
Comprehensible and straightforward to end user.

Thanks to modularity of presented invention, the technician can adapt the panel (user interface) in accordance to customer's needs, which means that only control segments which are really necessary will be installed. In future, the system can be further individually reduced or extended of other functions (if only one function is required, it is not necessary to purchase entire “pack” of unwanted features or elements). Said control panel can be tailored of individual elements.

The system is flexible to service technician. It enables simple setting and identification of particular peripheries (detectors) in small installation (family house), which corresponds to the desired features. On the other hand it gives the technician an option to configure the same system for complex installations (multiple alarm partitions, various levels of access to particular areas for particular groups of people, control of ancillary equipment, etc.).

For better orientation in more sophisticated installations when accessed remotely via a mobile phone, when user does not dispose of the control and indicating panel at the moment, the system has implemented easy custom help that provides the user with step-by-step audio guidance.

In fact, the common end user of the control and indicating panel does not require any keyboard to control it. He uses only operating elements of particular control segment (i.e., to turn off the air-conditioning the red button with “air-conditioning” written on the label shall be pressed; for opposite action the green button shall be pressed—the result is easy and clear to understand). If the control and indicating panel has a built in keyboard it can be hidden by fold-away cover so that it does not stress the common user, but on the other hand is well accessible for more sophisticated control, i.e. by service technician. The cover itself can also serve as one big button.

The multiple installation of several control and indicating panels in different places of a building, either with the same configuration (that is with identical setting, with identical control segments for identical group of users) or extended/reduced of other functions (that is different number of control segments and optional authorization units) according to the needs (i.e. at the building entrance is a control and indicating panel with all functions used in the entire system, which allows to set/unset alarm system for all floors and offices, turning on/off the air-conditioning in all floors and offices, control of lights for all floors and offices, by all authorized employees, whereas in the first floor there is another control panel installed with only segments to control functions in this particular floor).

### EXAMPLES OF EMBODIMENT OF THE INVENTION

### Example 1

A panel configuration with one control-and indicating segment A comprising label 2 and buttons 1, both buttons 1 being also status indicators of this segment, and authorization unit B, which comprises combination of keyboard 5, identification chip reader 6, display 4 and indicator 3. The control and indication elements of authorization unit B can be hidden with fold-away cover 8.

### Example 2

A panel configuration with eight control and indicating segments A comprising labels 2 and buttons 1, all buttons 1 being also status indicators of these segments A, and authorization unit B, which comprises combination of keyboard 5, identification chip reader 6, display 4 and indicator 3. The control and indication elements of authorization unit B can be hidden with fold-away cover 8.

### Example 3

A panel configuration with four control and indicating segments A comprising labels 2 and buttons 1, all buttons 1 being also status indicators of these segments A, and authorization unit B, which comprises combination of keyboard 5, identification chip reader 6, fingerprint reader 7, display 4 and indicator 3. The control and indication elements of authorization unit B can be hidden with fold-away cover 8.

### Example 4

A panel configuration with four control and indicating segments A comprising labels 2 and buttons 1, all buttons 1 being also status indicators of these segments A, and authorization unit B, which comprises combination of keyboard 5, identification chip reader 6 and indicator 3. The control and indication elements of authorization unit B can be hidden with fold-away cover 8.

### Example 5

A panel configuration with four control and indicating segments A and authorization unit B, the authorization unit B comprising only identification chip reader 6 and indicator 3.

### Example 6

An application of modular control and indicating panel in family house alarm system. The authorization unit B comprises combination of keyboard 5, identification chip reader 6, indicator 3 and display 4. The panel comprises three control and indicating segments. As displayed on FIG. 6, the lower segment serves to set/unset and indicates the status of garage partition, the middle segment is dedicated to set/unset and indicates the status of ground floor partition, and the top segment controls and indicates first floor partition. The modular control and indicating panel is interconnected with the alarm system control unit trough a wireless connection.

### Example 7

An application of modular control and indicating panel in administrative building alarm system with ten independent offices (partitions) and with option to turn on/off the central air-conditioning of the building. The authorization unit B comprises combination of keyboard 5, identification chip reader 6, fingerprint reader 7, display 4 and indicator 3. The panel comprises eleven control and indicating segments. As displayed on FIG. 7, first ten lower segments serve to set/unset and signalize the status of particular offices alarm surveillance. The top segment controls the air-conditioning. The modular panel is interconnected with control unit of the security system via cable.

### Example 8

An application of a modular control and indicating panel for a small shop alarm system. The authorization unit B comprises combination of keyboard 5, identification chip reader 6 and indicator 3. The panel has only one control and indicating segment dedicated to set/unset and to signalize the status of entire shop alarm system (see FIG. 8). The modular panel is connected to alarms system control unit via wireless connection. In this embodiment, the panel does not comprise display 4. Alarm system details are transmitted by the alarm system control unit to the users' mobile phones (via short text messages).

### Example 9

An application of modular control and indicating panel dedicated to control electric appliances only (heating, lights and ventilation of individual parts of the building). The authorization unit B comprises identification chip reader 6 and indicator 3. As shown on FIG. 9, the panel has six control and indicating segments: heating hall 1, heating hall 2, lights hall 1, lights hall 2, ventilation hall 1, and ventilation hall 2. The control and indicating panel is interconnected with control unit through cable. The control unit provides outputs to control particular appliance of the house.

### DISCLOSURE OF FIGURES

FIG. 1—modular control and indicating panel according to example 1

FIG. 2—modular control and indicating panel acc. to example 2

FIG. 3—modular control and indicating panel acc. to example 3

FIG. 4—modular control and indicating panel acc. to example 4

FIG. 5—modular control and indicating panel acc. to example 5

FIG. 6—application scheme of modular panel acc. to example 6

FIG. 7—application scheme of modular panel acc. to example 7

FIG. 8—application scheme of modular panel acc. to example 8

FIG. 9—application scheme of modular panel acc. to example 9

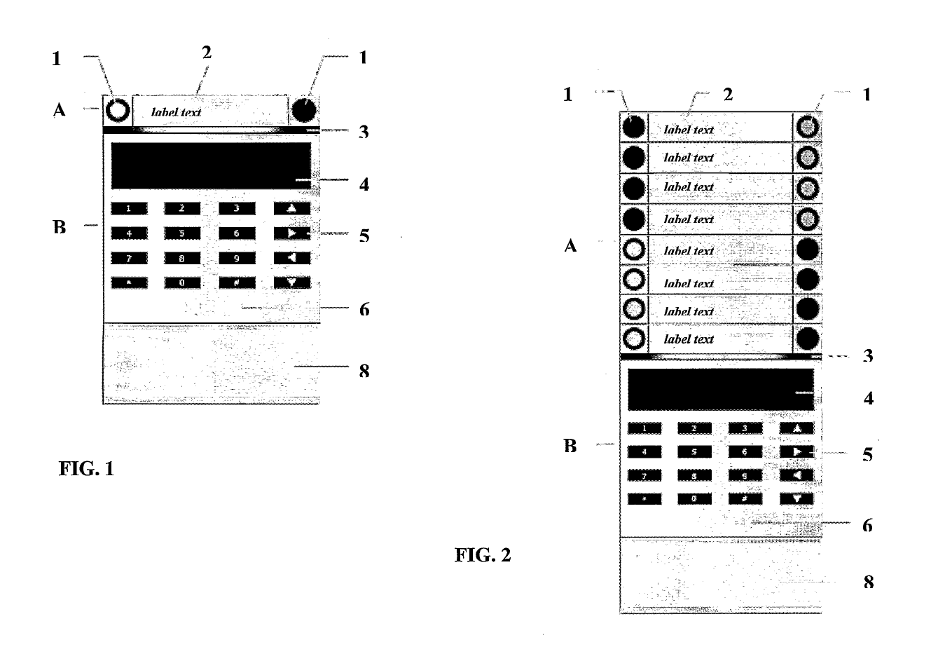

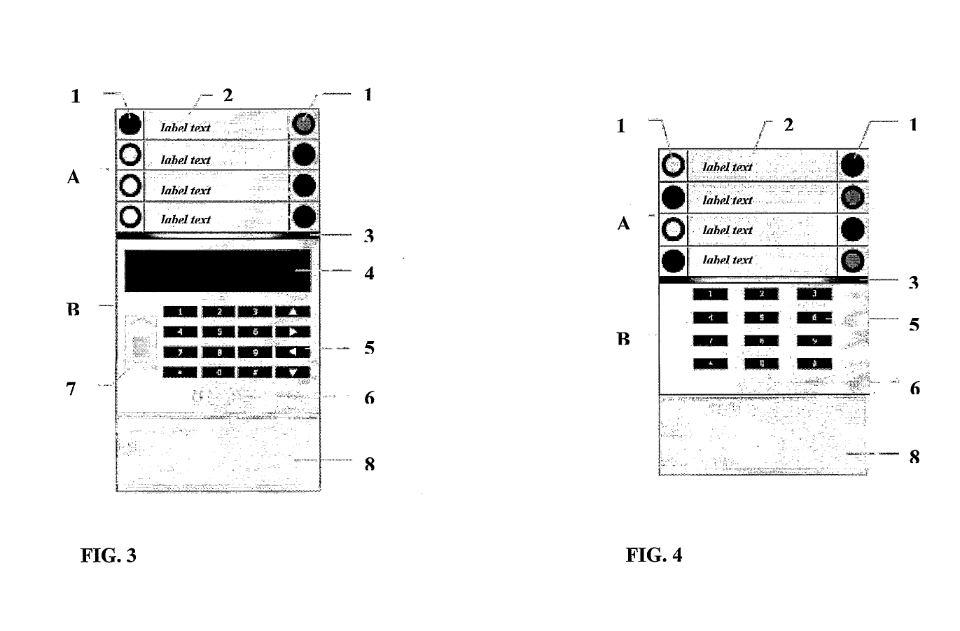

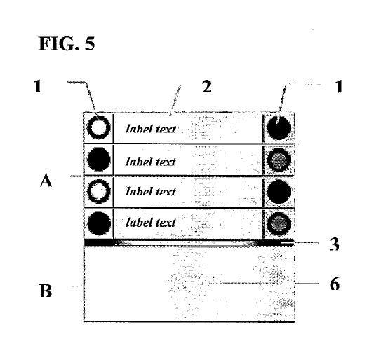

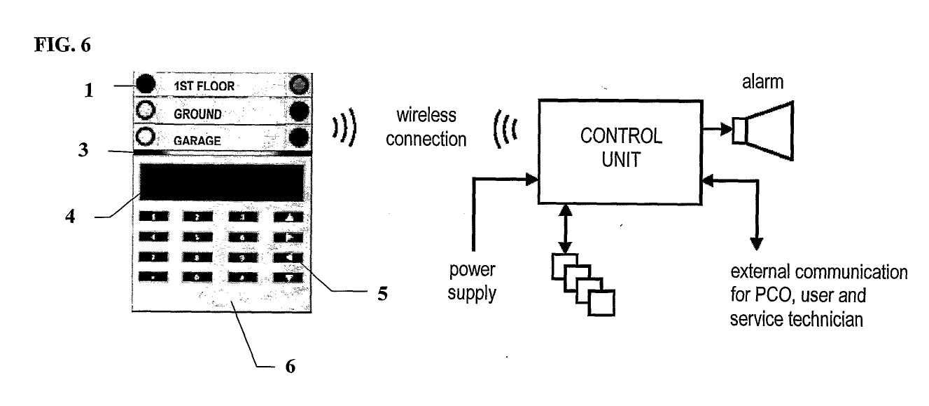

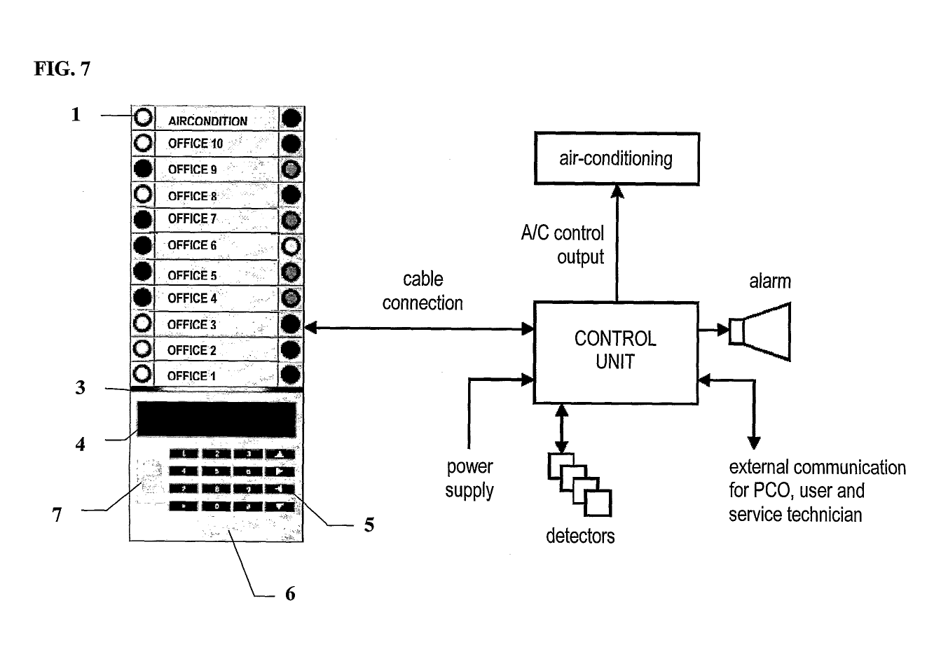

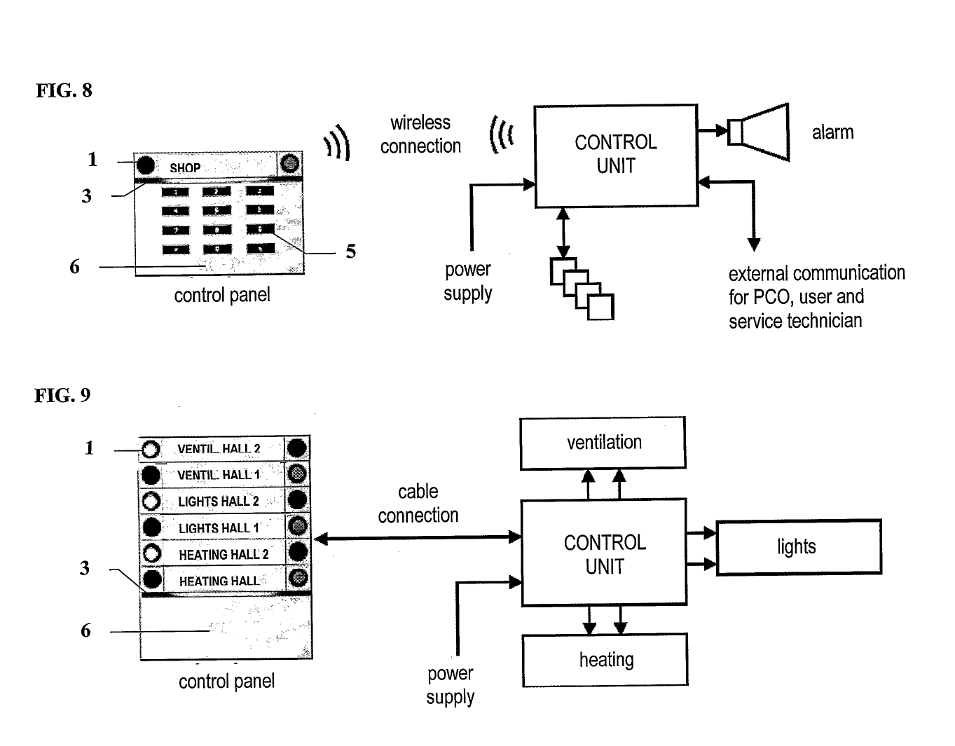

### INDUSTRIAL UTILIZATION

The invention is utilizable, for instance, for intruders alarm systems, fire alarms and other danger alarms. Further, it can be used for access control and for authorized and unauthorized control of various electric appliances in buildings.

### LIST OF REFERENCE MARKS

A—control and indicating segment/-s

B—authorization unit

1—button/-s of control and indicating segments

2—label of control and indicating segment

3—indicator of authorization unit

4—display

5—keyboard

6—identification chip reader

7—fingerprint reader

8—fold-away cover of authorization unit

1. Modular control and indicating panel, wherein the panel comprises authorization unit (B) and at least one or more control and indicating segments (A), the control segment (A) comprises label (2) and buttons (1), the authorization unit (B) comprises status indicator (3) equipped with device for authorization of the user, the panel can be configured with one or more control and indicating segments (A).

2. Modular control and indicating panel according to claim 1, wherein the control segment (A) comprises indicators of current status of controlled function.

3. One or more modular control and indicating panels according to claim 1, wherein the panel is connected into system, and all panels can have either identical or various configuration.

4. Modular control and indicating panel according to claim 1, wherein the authorization unit (B) comprises devices for users' authorization comprising various means of authorization: keyboard (5) or identification chip reader (6) or fingerprint reader (7) or other biometrical reader or wireless control receiver to receive identification code or various combinations of the listed means.

5. Modular control and indicating panel according to any of claim 1, 3 or 4, wherein the authorization unit (B) further comprises indicator of basic function of the system and indicates the process of authorization of the user.

6. Modular control and indicating panel according to any of claim 1, 3, 4 or 5, wherein the authorization unit (B) further comprises display (4), the display (4) providing more detailed information on status of controlled functions (or appliances), or text guide of the control.

7. Modular control and indicating panel according to any of claims 1 and 3 to 6, wherein the authorization unit (B) further comprises cover (8), the cover (8) providing optionally the function of activation of the identification chip reader (6) by its manipulation.

8. Modular control and indicating panel according to claim 1, wherein the authorization unit (B), in addition to status indicator (3), further comprises display (3) and/or keyboard (5) and/or identification chip reader (6) and/or fingerprint sensor (7) and/or fold-away cover (8).

9. Modular control and indication panel according to claim 1, wherein the buttons (1) of the control segment (A) indicate the status of the function.

10. Modular control and indication panel according to claims 1 and 9, wherein the buttons (1) are replaced with touch sensors or rotation encoder.

11. Modular control and indicating panel according to claims 1 and 10, wherein the control and indication panel is interconnected with the other system components trough wire (cable), or wireless via electromagnetic waves where the control and indication panel is supplied with energy from batteries (or batteries combined with a local power supply).

12. The modular control and indicating panel according to claims 1 to 11, wherein the panel is composed virtually of visual modules interpreted by program on touch screen.

13. The modular control and indicating panel according to claim 12, wherein chosen functions are assigned directly to particular users' authorization only so that after authorization of the user the assigned function is executed instantly (with no need to use any control and indicating segment).

14. The modular control and indicating panel according to claim 12, wherein predefined control segment(s) have assigned function(s) without need of any authorization (particular function(s) can be operated by anyone).

15. A method of securing by means of modular control and indication panel, wherein the control and indication panel is interconnected with the house system trough wire (cable), or wireless via electromagnetic waves where the control and indication panel is supplied with energy from batteries (or batteries combined with a local power supply).

16. The method of securing by means of modular control and indication panel according to claim 15, wherein multiple control and indication panels are simultaneously used within one security system.

17. The method of securing by means of modular control and indication panel according to claim 15, wherein the panel is composed virtually of visual modules interpreted by program on touch screen.

18. The method of securing by means of modular control and indication panel according to claim 15, wherein chosen functions are assigned directly to particular users so that after authorization of the user the assigned function is executed automatically, and predefined control segments have assigned the function without need of prior verification.

19. The use of modular control and indicating panel according to claims 1 to 14, for intruder alarms, fire alarms and other danger alarms, for access control and for authorized and unauthorized control of electric appliances, machines, tools or other facilities in the interior or exterior of buildings.
